(19) United States
(12) Patent Application Publication
(10) Pub. No.: US 2008/0169620 A1
(43) Pub. Date: Jul. 17, 2008

(54) Stroller and cart attachment

(76) Inventor: Sam Pierce, Hampton Bays, NY (US)

Correspondence Address: Thomas A. O'Rourke;Bodner & O'Rourke, LLP, 425 Broadhollow Road, Melville, NY, 11747, US

(21) Appl. No.: 11/653,197

(22) Filed: Jan. 12, 2007

(51) Int. Cl. B62B 3/14; B62B 9/00

(52) U.S. Cl. 280/33.993

(57) ABSTRACT

A stroller attachment that connects the stroller to a shopping cart, wherein a user can push and control both, the stroller and the cart simultaneously. The present invention includes a first shank, a second shank, at least one pivoting means, and a securing means. The pivoting means can include a ball joint or universal joint. These joints can be lockable, that is, once the second shank is in a desired position it can be locked into place. The first shank and second shank can be pivotally connected so that different angles can be achieved between the two shanks. In addition, there can be a securing means attached to one of the shanks. The securing can attach to a portion of the shopping cart.

### FIELD OF THE INVENTION

The present invention is directed to baby strollers, shopping carts, carriages, and the like, in particular the present invention relates to an improved connection means that allows a user to simultaneously control both a stroller and a shopping cart.

### BACKGROUND OF THE INVENTION

Parents with small children frequently have to run errands and must take the child along. These trips can include several stops. It is not uncommon that once the child is placed in the car seat and the car starts traveling that the gentle motion of the car causes the child to fall asleep. One problem has been that once you arrive at the destination, the sleeping child must be removed from the car seat and as a result, the child awakens. To solve this problem, some stroller manufacturers have designed strollers where the car seat can be easily removed from the car and combined with the stroller or shopping cart so as not to wake the child. When the destination is a supermarket or retail store where shopping carts are used, the parent must remove the child from the stroller and place him or her in the shopping cart's child seat. This frequently wakes the child and in many instances the child cries for an extended period because of the change of position.

In other instances when a child is in a stroller at a mall with a number of stores, the child may also fall asleep in the stroller. When the parent reaches the supermarket or other store with a shopping cart, the child may or may not be asleep, but is usually comfortable. In order to use the shopping cart, the parent currently must disturb the child and remove him or her from the stroller and place them in the shopping cart's child seat. The end result is the same for the sleeping child. The child awakens and is either unhappy at being awoken or becomes a shopping assistant pleading with the parent for inappropriate purchases that have caught his eye.

One of the problems with the traditional shopping cart has been safety. The child seat of many shopping carts does not secure the child well. There is usually no strap or if there is one, the strap has been worn. Hygiene is also an issue with these carts as well. Small children mouth the handle and other parts adjacent to the child seat, which is not necessarily the cleanest area. As a result, many parents would like to use their stroller while shopping.

In order to use a shopping cart and keep the child in the stroller, it has traditionally required that there be two people available, one to operate the shopping cart and the other to handle the stroller. In view of these difficulties, there is a need for a combination shopping cart and stroller or a clip to combine a stroller and a cart that will permit the child to remain in the stroller while the parent can operate the shopping cart.

### OBJECT OF THE INVENTION

It is an object of the invention to provide a system whereby a stroller can be connected to a shopping cart so that a child need not be removed from the stroller while a parent is shopping.

It is also an object of the invention to provide a system whereby a stroller can be combined with a shopping cart so that the two may be operated by a single individual.

It is another object of the invention to provide an improved stroller shopping cart combination that may be used together or separately.

It is a still further object of the invention to provide a means for securing a stroller and shopping cart together so that the two may be operated together by a single individual.

It is also an object of the invention to provide a clip or device to secure a shopping cart and stroller together so that a parent does not have to remove a child from a stroller while using a shopping cart.

It is also an object of the invention to provide a clip or device that is part of a stroller to permit the stroller to be secured to a cart.

It is another object of the invention to provide a clip or device that is part of a cart to permit the cart to be secured to the stroller.

It is still another object of the invention to provide a clip or device that is separate and independent from a stroller and a cart that permits a stroller and cart to be joined together.

It is still a further object of the invention that there be a safer seat for a child than the traditional shopping cart child seat.

It is also an object of the invention to provide a clip or device that permits a hand held type shopping basket to be secured to the handle or other part of a stroller or shopping cart.

It is also an object of the invention to provide a clip that is part of a stroller that permits a hand held type basket to be secured to the handle or other part of a stroller.

### SUMMARY OF THE INVENTION

The apparatus of the present invention allows a user to connect a stroller to a shopping cart. The shopping cart can be any of the traditional carts with a set of three or more wheels. Usually there are four wheels on many carts. Frequently, at least one or more of the wheels swivels to permit the cart to turn easily in the tight confines of a store aisle. The cart usually has a basket for receiving items to be purchased. The basket can be made of a wire mesh or can be a plastic material or other suitable configuration. There is frequently a second storage area under the basket and directly above the wheels where large bulky items can be placed. The cart is typically steered by a horizontal handle at the rear of the cart where there is generally a smaller basket for seating a child or for holding goods.

The stroller portion of the configuration can be any stroller device. The strollers typically have a sitting area for a child and are supported usually by four or more wheels. Two of the wheels, most frequently the front, swivel for easy maneuverability. At least the rear wheels are usually double wheeled. Many of the strollers used today fold to a reduced size after use. For example, there can be the so called “umbrella strollers” that collapse so that one side contacts the other side. Another type of stroller is one that has a horizontal handle. These strollers typically fold down. In this stroller, the base and handles usually fold toward each other.

In the present invention, the stroller is designed so that it can be removably attached to the front of the shopping cart. In this embodiment, the handle(s) or the frame of the stroller is secured to a device which can be secured to the shopping cart so that the stroller can maneuver with the shopping cart. In a preferred embodiment, the stroller has four wheels or wheel assemblies whereby all four are rotatable. In another embodiment, the stroller's rear wheels are lifted off the ground so that the rear wheels of the stroller do not interfere with the movement of the combination stroller and cart assembly.

The stroller can be secured to the shopping cart by any suitable means including but not limited to a clip, a velcro type hook and eye fastener, by magnets or by any other suitable means. One preferred means of securing the shopping cart to the stroller is the presence of one or more, usually two clips or connecting means. These connecting means have a first section which is generally in the form of generally an inverted “U”. The inverted U can have curved side walls if desired. The inverted U is positioned over the top edge of the front portion of the shopping cart. Extending downwardly from the outside of the inverted U is a body member. The body member has a first end connected to the inverted U. The second end has a J or U shape. The J shaped portion is to receive a horizontal bar on a stroller and hold it connected to the shopping cart. Although the clip has been described as generally U shaped, it will be appreciated that the clip does not need to have a curved shape. The individual portions of the U shaped portion may be at right angles to each leg of the U. The body member or shank can be any suitable length. In one embodiment, the body member can be capable of telescoping to adjust the length of the body member.

Usually there would be at least two clips for a horizontal hand held stroller. The clip may be in the form of a circular rod or a thin flat strip. Usually the clip will be made of metal and preferably have a plastic coating over it so that it does not mar the surface it contacts. The clip may have an orifice through each of the U shaped members so that a threaded member can be inserted to secure the clip to the stroller and on the shopping cart. The threaded member can be used to prevent the cart or stroller from becoming free of the clip. It will be appreciated that other securing means can be used to secure the clip to the stroller and to the cart.

Where the stroller hand hold has a different configuration, an alternate clip arrangement can be used. For example, where the stroller is an umbrella type stroller, the handles for these strollers are hook shaped or an inverted U, the clip can be of a different configuration. In one embodiment of this configuration, the handles of the strollers go over the top edge of the shopping cart. In order to restrain the stroller while it is in position over the cart, there is a clip that is connected to the end of the stroller arm and which has an open end which rests on a top surface of the edge of the cart. In an alternative embodiment the end of the clip opposite the stroller can pass through an orifice in the shopping cart and is secured to the cart. The clip can be secured to the cart and the stroller by a variety of means. For example, the clip can have a spring that snaps shut on the cart, or a gripping means that secures the stroller to the cart. Alternatively, there can be a coating on the inside to hold it the clip in place on the cart as well as other suitable securing means. These configurations and others restrain the stroller and prevents it from being dislodged.

The clip in this configuration can include a main body having a first end and a second end. The main body may be a thin rod or strip that is flat on a top and body surface. At one end there is a ring or hook that is secured to one part of the handle of the stroller. There is a second ring or hook on the opposite side of the main body that is used to secure the clip to the stroller arm. The ring or hook can be in any configuration as long as it secures the clip to the stroller or the cart. For example, the clip can be in the form of a rod that goes around a substantial portion of the handle. A hinged member can swing inwardly so that the ring can receive the handle of the stroller. Once the handle is in place, the hinged member swings back into position and prevents the handle from being released. In order to remove the stroller handle from the ring, the hinged member is pushed inwardly and the handle can be removed.

It will be appreciated that other arrangements are possible.

### BRIEF DESCRIPTION OF THE DRAWINGS

FIG. 1 is a representation of the connecting means of the present invention.

FIG. 2 is an alternative clip of the present invention.

FIG. 3 is a representation of an alternate embodiment clip of the present invention.

FIG. 4 is an example of an additional retaining means for securing the stroller or cart to the shank.

FIG. 5 is an example of the clip of the present invention used to hold a hand held basket on the stroller handle.

FIG. 6 is an example of a prior art stroller.

FIG. 7 is a cross-sectional side view of an example of a ball joint used in the present invention.

FIG. 8 is an exploded view of a prior art universal joint, which includes two shanks.

FIG. 9 is the universal joint, as depicted in FIG. 8, with the shanks oriented along the same general plane.

FIG. 10 is the universal joint, as depicted in FIG. 8, with the shanks slightly angled.

FIG. 11 is a side view of an alternative embodiment of the clip of the present invention.

FIG. 12 is a side view of another embodiment of the clip of the present invention.

FIG. 13 is a side view of still another embodiment of the clip of the present invention.

FIG. 14 is a side view of yet another embodiment of the clip of the present invention.

FIG. 15 is a side view of yet another embodiment of the clip of the present invention.

These and other objects of the present invention will become apparent to those skilled in the art from a review from the description provided below.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

All citied references are incorporated herein by reference in their entireties. Citation of any reference is not an admission regarding any determination as to its availability as prior art to the claimed invention.

Turning now descriptively to the drawings, in which similar reference characters denote similar elements throughout the several views, the figures illustrate the present invention. The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

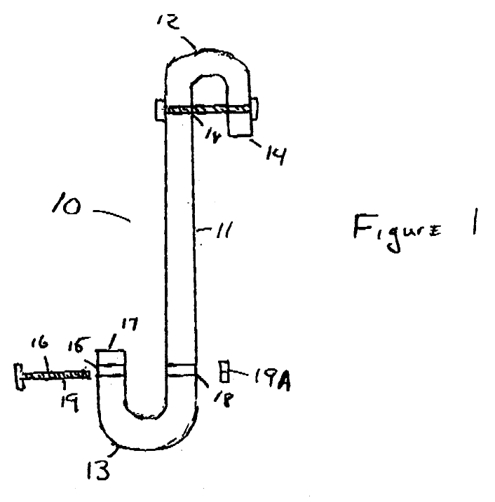

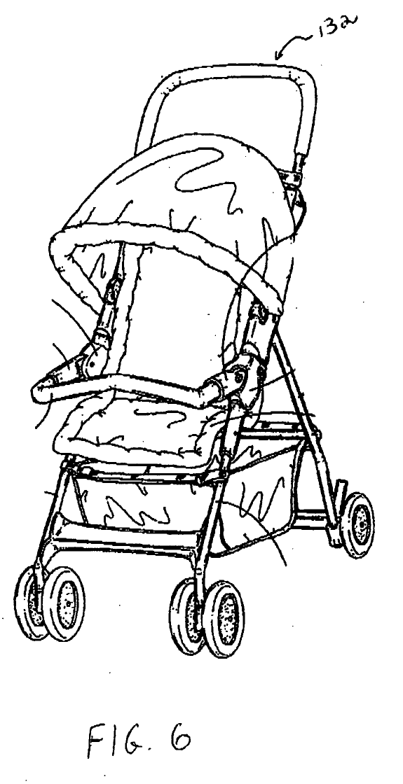

As seen in FIG. 1, there is a clip 10 having a shank portion 11 and an upper receiving member 12 and a lower receiving member 13. The shank may be a rod shaped member or it may be a flat sheet or any other suitable shape. The clip may be made of any suitable materials such as plastic, metal, etc. Although shown with a curved portion, the receiving members 12 and 13 can be any suitable shape. In the vicinity of the tip 14 of the receiving member, there may be a clamp such as a spring clamp or a clamp with two jaws that secure the clip to handle 13a of the stroller. The upper receiving member 12 may be held in place on the edge of a cart by gravity or there may be an adhesive on the inner contact surface of the receiving member. Alternatively, there may be an orifice 15 for receiving a securing means 16. The opposing tip 17 may also have a clamp such as a spring clamp or a clamp with two jaws that secure the clip to the handle. Alternatively, there may be an orifice 18. The securing means may be a bolt or a threaded member 19 that passes through the orifices. A nut 19A or other securing device on the threaded member may be used to retain the securing means in position. The securing means prevents the stroller or cart from being separated from the assembly. This embodiment has particular applicability for strollers that are pushed using a generally horizontal bar, as seen in FIG. 6.

In another embodiment, as seen in FIG. 11, clip 100 can include a bracket member 110 that is attached to the shopping cart and a hook member 120 that secures the stroller. Generally, the clip in this embodiment will be sized so as to allow for maximum support and minimal interference with grocery placement and/or removal. In addition, clip 100 can come in any variety of colors or shades. In the present invention members 110 and 120 can be machined together, as in the preferred embodiment. In another embodiment, members 110 and 120 can be two separate members attached together. With this embodiment, members 110 and 120 can be attached by any suitable attaching means known in the available art, including, but not limited to bolting, screwing, gluing and the like.

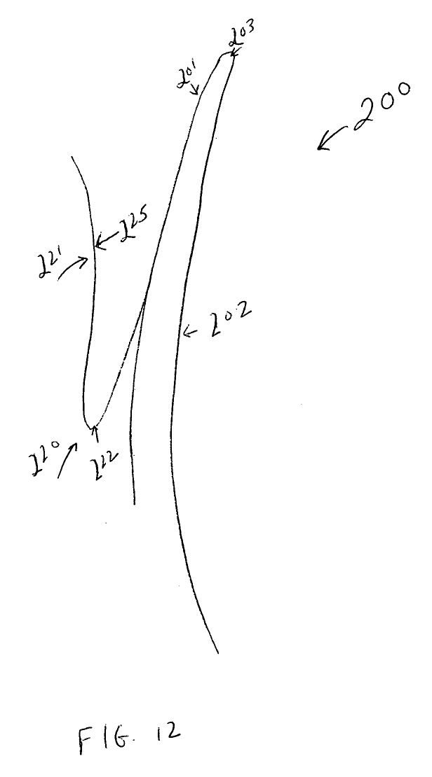

In the embodiment represented by FIG. 11 bracket 110 can have a front surface 101 and a rear surface 102 that is joined at an apex 103. Bracket 110 can be made out of any suitable material available in the known art, including, but not limited to plastic, metal, and the like. In a preferred embodiment member 110 was manufactured from a strong resilient plastic. Attached to front surface 101 can be hook member 120. In a preferred embodiment hook 120 can extend outwardly from surface 101 in a generally perpendicular direction. Hook 120 can have any suitable shape known in the available art. In a preferred embodiment hook 120 can have a side surface 121 and a bottom surface 122 that are perpendicular to each other and form a right angle, as seen in FIG. 11. The key feature of hook 120 is that it should extend a distance from surface 101 that will allow one to place the handle of the stroller between the inside surface 125 of hook 120 and the outside surface 101 of bracket 110. In another embodiment, as seen in FIG. 12, clip 200 can have a hook member 220 that has an arcuate bottom surface. In this embodiment hook 220 can extend in a generally downward direction parallel to surface 201 of clip 200.

In either of the aforementioned embodiments, as represented by FIGS. 11 and 12, hooks 120 and 220 can extend the entire width of brackets 101 and 201, respectively. Conversely, hooks 120 and 220 can extend a distance less than the entire width of brackets 101 and 201, respectively. This will depend on the desires of the manufacturer and the desires of the user. Also, there can be one or multiple hooks located on surfaces 101 and 201. Furthermore, the hooks of these embodiments can extend the entire length of the brackets.

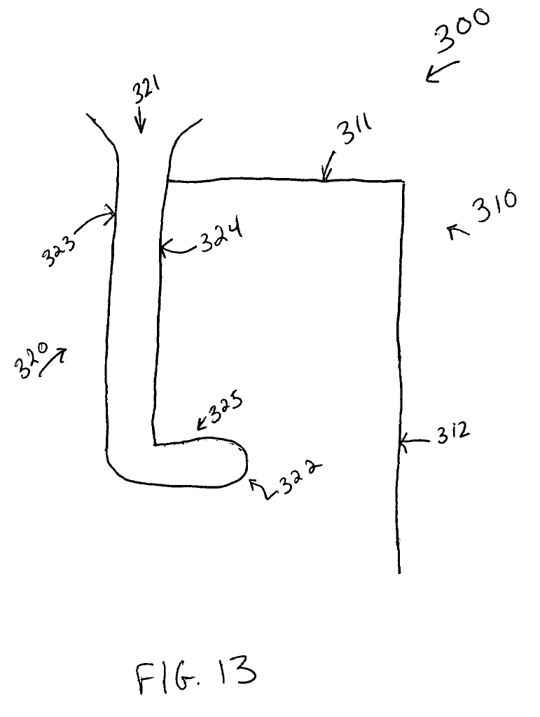

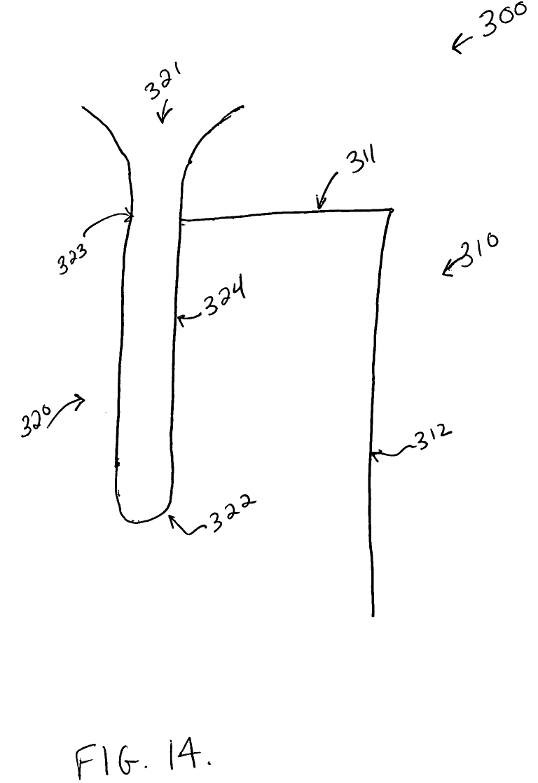

Drawing one's attention to FIG. 13 is an alternative embodiment. Clip 300 includes a bracket 310 and a holder 320. Clip 300 can be constructed from any of the aforementioned materials, that is, plastic, metal, and the like. In addition, bracket 310 and holder 320 can be machined together or attached via any of the previously mentioned methods.

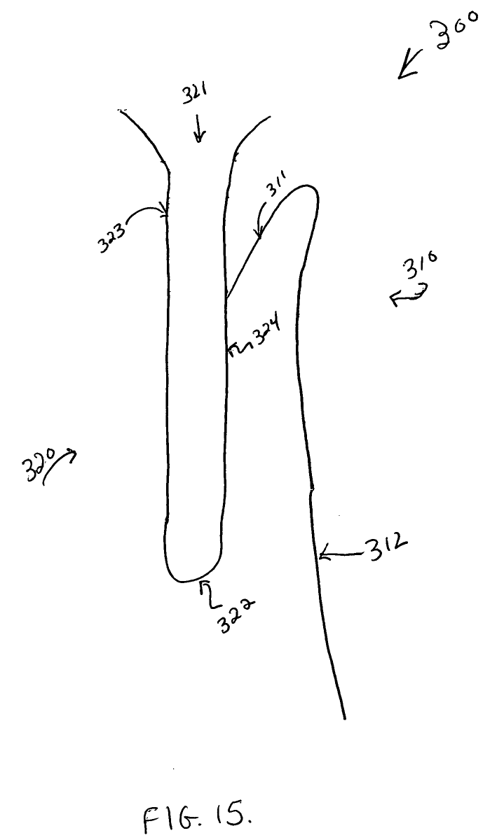

Bracket 310 can include a top surface 311 and a side surface 312. Top surface 311 can extend outwardly and in a generally perpendicular direction from holder 320. Side surface 312 and top surface 311 can be generally perpendicular to each other and form a right angle at a top corner. Side surface 312 can extend in a generally downward direction, parallel to holder 320. In an alternative embodiment top surface 311 and side surface 312 of bracket 310 can merge at a peak 331, as seen in FIG. 14.

Drawing one's attention again to FIG. 13 is holder 320 of the present invention. Holder 320 can have an open top end 321 and a closed bottom end 322. Holder 320 can have a front surface 323 and a rear surface 324 that are joined at bottom end 322. Surfaces 323 and 324 are spaced apart so as to be able to receive the handle from a stroller. In a preferred embodiment, bottom end 322 of holder 320 can have an “L” shape 325. This curvature can form a resting area for the handle of the stroller.

Mentioned previously, bracket 310 and holder 320 can be one machined unit or two separate and attachable units. In the latter embodiment rear surface 324 of holder 320 can have one or multiple slots or grooves and bracket 310 can have one or multiple tabs or tongues. These slots and tabs can be easily connected and removed from each other. The utility of this embodiment becomes evident where the stroller is of unconventional nature and/or dimensions. This embodiment allows the user to adjust clip 300 to an appropriate position.

Other embodiments can include brackets that are smaller. With these embodiments there can be one or multiple brackets that can be attached to the shopping cart.

In normal operation, of the embodiments represented by FIGS. 11 and 12, the user will place one of the aforementioned brackets over front top edge of the shopping cart. Next, the user will place the handle of the stroller between the hook member and the bracket.

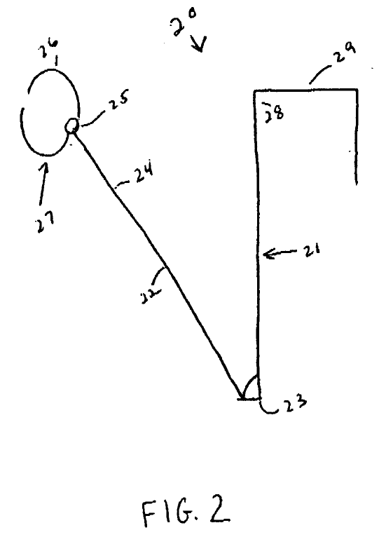

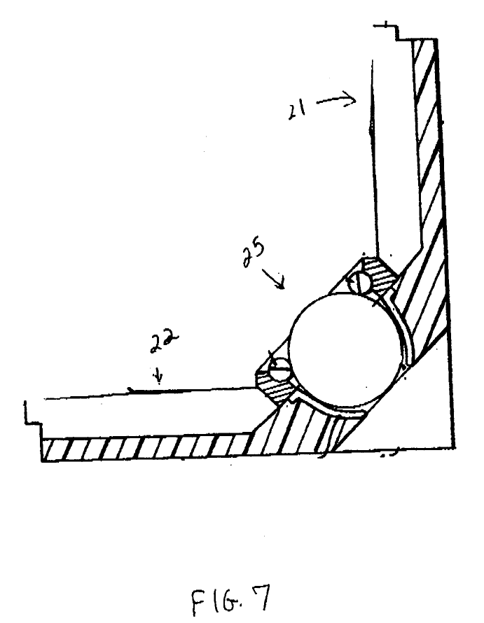

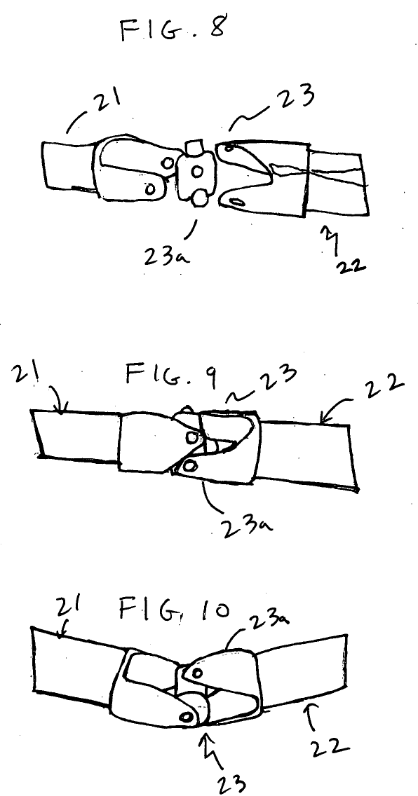

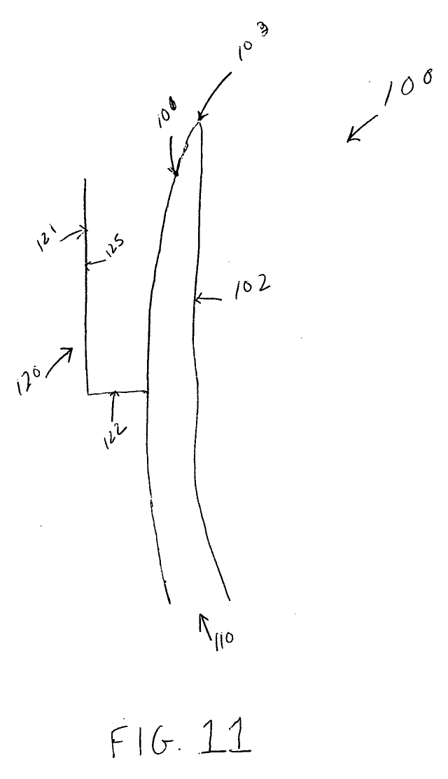

FIG. 2 shows an alternative embodiment of the present invention. In the example of the clip 20 shown in FIG. 2, there is a first shank 21 and a second shank 22. The first and second shanks are joined by a joint 23 that permits the second shank to move, at least up and down. In a preferred embodiment, the joint 23 preferably can lock in a desired position. One type of joint that has proven utility with this embodiment is the universal type joint 23a, as seen in FIGS. 8-10. At this time it should be pointed out that the universal joint should have a locking means to secure it into position. At the end 24 of the shank 22 opposite the joint 23, there is a ball joint 25 that has a pair of clamping arms 26 and 27. Ball joint 25 can be of any suitable type of ball joint known in the available art. A typical ball joint can be seen in FIG. 7. On the end 28 of the shank 21, there is a hook arrangement 29 that goes over the edge of the cart. The clamp of the present invention is preferably made from a sturdy plastic. The clamp should be flexible or have some spring in it as well. The ball joint may have a locking means to secure the jaws 26 and 27 in position. Alternatively, the ball portion of the joint may have a good friction fit with the socket where the friction holds the ball portion in position.

The above joint types are only but a few of the numerous types of joints available in the art. In addition to the numerous types of joints that can be implemented, there can be a plethora of different joint arrangements. For instance, joint 23 can be a ball joint and joint 25 can be a universal joint, or vice-a-versa. In yet another embodiment joints 23 and 25 can be of the same type, that is, two universal joints. In still yet another embodiment joints 23 and 25 can both be ball joints.

In an alternative embodiment shanks 21 and 22 can be machined to a fixed angle. For example, shank 22 can be attached to shank 21 by any suitable means known in the available art, including, but not limited to soldering, welding, brazing and the like. In addition, shank 22 can be attached to shank 21 at an angle between 0 and 180°, this will depend on the manufacturer's specific needs.

Also, in a different type of embodiment shank 22 can be attached to shank 23, via a tongue and groove system. For example, shank 23 can have two opposing slots, located on the front face of shank 23 that traverses upwards and extends towards each other. With this type of embodiment, shank 22 might have a tongue that extends in a generally perpendicular direction and can be positioned inside of the grooves of shank 23. This would allow shank 22 to move in the vertical axis. Also included with this embodiment is a locking means. For example, there can an aperture that extends from a first side of the tongue portion of shank 22 to a second side of the tongue portion of shank 22. This same type of aperture can be located on shank 23. Any suitable type of securing means known in the available art can be used, including, but not limited to a nut and bolt and the like. A different locking means can include apertures on shank 22 and 23 that are threaded, in which case a simple threaded screw can be used to secure shank 22 to shank 23.

In an alternative embodiment a portion of the tongue can have teeth and the front face of shank 23 can have grooves that mesh with the teeth of the tongue portion of shank 22. This configuration can of course be reversed, that is, shank 22 can have grooves and shank 23 can have teeth.

In normal operation the user will insert the tongue of shank 22 into the grooves of shank 23. Once the desired height is achieved the user will then secure shank 22 to shank 23 via one of the aforementioned securing methods.

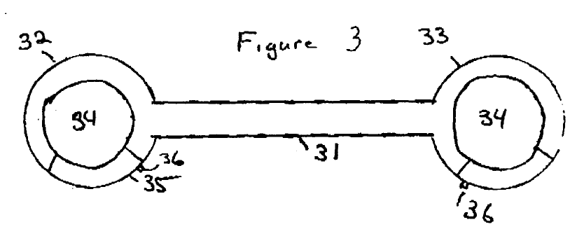

FIG. 3 shows a still further example of the present invention. This embodiment is primarily used for umbrella type strollers. This clip 30 has a shank 31 with a ring shaped member 32 and 33 at each end. The ring shaped member has an open section 34 for receiving the handle of the stroller. A securing means 35 across one portion of the ring will hold the stroller or the cart in place. In this embodiment, the ring may have a hollow cross section with a spring therein. A portion 35 of the ring may have a protrusion 36 to move the ring portion 35 into the hollow cross section of the ring for insertion of the stroller or cart. Once the stroller or cart is in position, the spring forces the ring portion 35 back into position to hold the stroller in place.

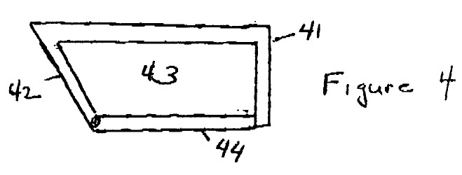

FIG. 4 shows an alternative embodiment of a securing means 41. This has a ring portion 42 and a receiving section 43. There is a swing arm 44 that can swing inwardly or outwardly to receive the stroller or the cart. Once the cart is in place, the arm 44 can be locked in position.

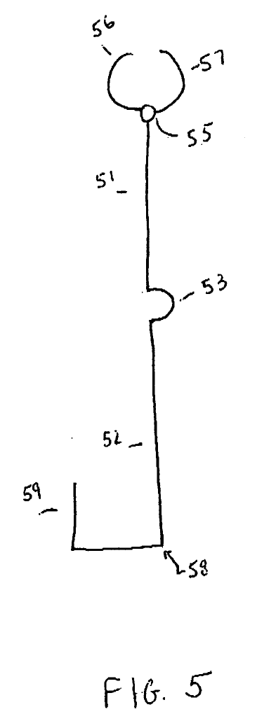

FIG. 5 shows the embodiment of FIG. 2 arranged to support a basket. There are the first and second shanks 51 and 52 joined by a joint 53. The joint 53 permits the shanks to be positioned at a variety of angles including the arrangement shown in this figure. The jaws 56 and 57 attached to the ball joint 55 secure the clip to the stroller handle. At end 58 there is a hook arrangement 59 into which a hand held type basket may be placed.

While the embodiments have shown the retaining means marching on both sides of the shank, it will be appreciated that different combinations are possible.

As various changes could be made in the above constructions without departing from the scope of the invention, it is intended that all matter contained in the above description shall be interpreted as illustrative and not in a limiting sense. In the view above it will be seen that several objects of the invention are achieved and other advantageous results attained, as defined by the scope of the following claims.

What is claimed is:

1. A stroller attachment for a shopping cart comprising:
a holder, said holder having a top end and a bottom end, said top end having an opening and said bottom end being closed, said holder further comprising a front surface, and a rear surface said front and rear surfaces joining at said bottom end said front and rear surfaces being spaced apart so as to be able to receive a portion of a stroller handle between said front and rear surfaces; and
a bracket, said bracket extending from said rear surface of said holder said bracket having a first member extending from said rear surface and a second member extending from said first member said second member and said rear surface being spaced apart so to be able to receive a portion of a grocery cart therebetween.

2. The stroller attachment according to claim 1 wherein said bracket further comprises: said first member extends from said rear surface of said holder in a generally perpendicular direction to said rear surface and said second member being generally parallel to said rear surface of said holder.

3. The stroller attachment according to claim 2 wherein said bottom end of said holder has a slightly curved portion, said curved portion serving as a resting area for said stroller handle.

4. The stroller attachment according to claim 3 wherein said bracket is removably attached to said holder.

5. A stroller attachment for a shopping cart comprising:
a means for securing said attachment to a shopping cart; and
a first shank extending from said means; and
a second shank having a first end and a second end said shank being rotably connected to said first shank at said first end such that the angle between said first and second shanks can be adjusted said second shank having clamping means at said second end said clamp means adapted to secure a stroller to said shopping cart.

6. The attachment according to claim 5 wherein said means for securing said attachment to a shopping cart comprises a first arm and a second arm extending from said first shanks said first arm and said second arm forming a right angle to each other.

7. The attachment according to claim 6 wherein said second arm and said first shank form generally a right angle to each other.

8. The attachment according to claim 7 wherein said first shank is connected to said second shank by means of a universal joint.

9. The attachment according to claim 8 wherein said universal joint is lockable to cause said shanks to be in a fixed angle.

10. The attachment according to claim 7 wherein said first shank is connected to said second shank by means of a ball joint.

11. The attachment according to claim 10 wherein said universal joint is lockable to cause said shanks to be in a fixed angle.

12. The attachment according to claim 9 wherein said second end of said shank has a universal joint joining said clamping means.

13. The attachment according to claim 9 wherein said second end of said shank has a ball joint joining said clamping means.

14. The attachment according to claim 11 wherein said second end of said shank has a universal joint joining said clamping means.

15. The attachment according to claim 11 wherein said second end of said shank has a ball joint joining said clamping means.

16. The attachment according to claim 7 wherein said first and second shanks are made of a sturdy plastic.

17. The attachment according to claim 5 wherein said securing means further comprises a ring portion and a receiving section wherein said ring portion has a pivotally connected arm attached thereto.

18. The attachment according to claim 5 wherein said securing means further comprises a shank having a ring shaped member at each end, said ring shaped member having an open section for receiving a handle of said stroller.

19. The attachment according to claim 18 wherein said rings each may have a hollow cross section with a spring therein, said ring having a retractable member attached to said spring, said retractable member having a protrusion extending therefrom, said protrusion allowing the user to push said retractable member into said cross section of said ring when receiving said stroller handle.

20. A stroller attachment for carrying a basket comprising a clamping means for securing said attachment to a stroller a first shank extending from said clamping means said first shank having a first end attached to said clamping means said first shank being rotably connected to a second shank said second shank being adapted to be locked in a position such that said first and second shanks are generally in the same plane, said second shank having a first end connected to said first shank and a second end having a hook means, said hook means being adapted to carry a handle of a basket.
